(19) United States
(12) Patent Application Publication
(10) Pub. No.: US 2011/0139755 A1
(43) Pub. Date: Jun. 16, 2011

(54) MULTI-WAVELENGTH LASER-SCRIBING TOOL

(75) Inventors: Antoine P. Manens, Sunnyvale, CA (US); Wei-Yung Hsu, San Jose, CA (US); Manivannan Thothadri, Mountain View, CA (US); Arthur Kenichi Yasuda, Belmont, CA (US)

(73) Assignee: Applied Materials, Inc., Santa Clara, CA (US)

(21) Appl. No.: 12/939,137

(22) Filed: Nov. 3, 2010

Related U.S. Application Data
(60) Provisional application No. 61/257,767, filed on Nov. 3, 2009.

(51) Int. Cl. B23K 26/00

(52) U.S. Cl. 219/121.67

(57) ABSTRACT

Multi-wavelength laser-scribing systems are disclosed. A system for scribing a workpiece includes a frame, a translation stage coupled with the frame to support the workpiece and translate the supported workpiece relative to the frame in a longitudinal direction, at least one laser operable to generate a first output having a first wavelength and generate a second output having a second wavelength, and at least one scanning device coupled with the frame and operable to control a position of the first and second outputs. Each of the first and second outputs are able to remove material from at least a portion of the workpiece. Laser assemblies that each include a laser and at least one scanning device can be arranged in rows to enhance the rate at which latitudinal scribe lines are formed.

### CROSS-REFERENCES TO RELATED APPLICATIONS

The present application claims the benefit of U.S. Provisional Patent Application No. 61/257,767 filed Nov. 3, 2009, and titled “MULTI-WAVELENGTH LASER-SCRIBING TOOL” and incorporated herein by reference for all purposes. The present application is related to U.S. patent application Ser. No. 12/851,422, entitled “METHODS AND RELATED SYSTEMS FOR THIN-FILM LASER SCRIBING ENHANCED THROUGHPUT,” filed on Aug. 5, 2010, the full disclosure of which is incorporated herein by reference.

### BACKGROUND

Various embodiments described herein relate generally to systems for scribing or patterning a workpiece, and more particularly to systems for laser scribing a workpiece using two or more laser output wavelengths. Such systems can be particularly effective for laser-scribing glass substrates having at least one layer used to form thin-film solar cells.

Current methods for forming thin-film solar cells involve depositing or otherwise forming a plurality of layers on a substrate, such as a glass, metal or polymer substrate suitable to form one or more p-n junctions. An example thin-film solar cell includes a glass substrate having a transparent-conductive-oxide (TCO) layer, a plurality of doped and undoped silicon layers, and a metal back layer. Examples of materials that can be used to form solar cells, along with methods and apparatus for forming the cells, are described, for example, in U.S. Pat. No. 7,582,515, issued Sep. 1, 2009, entitled “MULTI-JUNCTION SOLAR CELLS AND METHODS AND APPARATUSES FOR FORMING THE SAME,” which is hereby incorporated herein by reference.

When a panel is formed from a large substrate, a series of laser-scribed lines is can be used within each layer to delineate individual cells. FIG. 1 diagrammatically illustrates an example solar-cell assembly 10 that includes scribed lines, for example, laser-scribed lines. The solar-cell assembly 10 can be fabricated by depositing a number of layers on a glass substrate 12 and scribing a number of lines within the layers. The fabrication process begins with the deposition of a TCO layer 14 on the glass substrate 12. A first set of lines 16 (“P1” interconnect lines and “P1” isolation lines) are then scribed within the TCO layer 14. A plurality of doped and undoped amorphous silicon (a-Si) layers 18 are then deposited on the TCO layer 14 and within the first set of lines 16. A second set of lines 20 (“P2” interconnect lines) are then scribed within the silicon layers 18. A metal layer 22 is then deposited on the silicon layers 18 and within the second set of lines 20. A third set of lines 24 (“P3” interconnect lines and “P3” isolation lines) are then scribed as illustrated.

The cost of production of thin-film solar cells is influenced by the cost of production of the scribed assemblies (e.g., solar-cell assembly 10) used to produce the solar cells, which in turn is influenced by the manufacturing throughput of the scribed assemblies. Accordingly, it is desirable to develop improved systems for scribing workpieces. More particularly, it is desirable to develop systems that can be used to improve manufacturing throughput for laser-scribing assemblies used to form thin-film solar cells.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some aspects and embodiments in a simplified form as a prelude to the more detailed description that is presented later.

Systems in accordance with various aspects and embodiments are disclosed for laser-scribing a workpiece. The disclosed systems are operable to remove material from a workpiece using laser output of a first wavelength and/or laser output of a second wavelength. For example, an infrared wavelength (e.g., 1064 nm) can be used to scribe lines where the removal of material from the TCO layer is involved (e.g., P1 interconnect lines and P1 isolation lines), and a green wavelength (e.g., 532 nm) can be used scribe lines where the removal of material from the TCO layer is not involved (e.g., P2 interconnect lines, P3 interconnect lines, as well as P3 isolation lines formed on existing P1 isolation lines). The ability for a single scribing system to form each of the types of scribe lines in a solar cell assembly provides increased manufacturing flexibility as compared to the use of individually dedicated single-wavelength scribing systems (e.g., a dedicated single-wavelength system for form P1 lines, another dedicated single-wavelength system to form P2 lines, and another dedicated single-wavelength system to form P3 lines). Such increased flexibility can be used in increase manufacturing throughput, and can be used to configure manufacturing cells where production can continue even when individual scribing machines are offline (e.g., for maintenance, for repair).

Thus, in a first aspect, a system for scribing a workpiece is disclosed. The system includes a frame, a translation stage coupled with the frame to support the workpiece and translate the supported workpiece relative to the frame in a longitudinal direction, at least one laser operable to generate a first output having a first wavelength and generate a second output having a second wavelength, and at least one scanning device coupled with the frame and operable to control a position of the first and second outputs. Each of the first and second outputs are able to remove material from at least a portion of the workpiece.

In many embodiments, the multi-wavelength scribing system includes at least one additional feature and/or characteristic. For example, the first wavelength can be an infrared wavelength, for example, 1064 nm. The second wavelength can be a green wavelength, for example, 532 nm. The scribing system can include a laser operable to generate both the first and second outputs (e.g., a laser operable to selectively employ second-harmonic generation to convert 1064 nm output to 532 nm output). In many embodiments, the at least one laser includes at least one first laser operable to generate the first output, and at least one second laser operable to generate the second output. The at least one scanning device can include a plurality of scanning devices arranged in two or more offset rows oriented traverse to the longitudinal direction. The system can include an adjustment mechanism to adjust a longitudinal separation between two rows of scanning devices. The system can include a first lateral translation mechanism operable to translate a first of the offset rows traverse to the longitudinal direction, and can include a second lateral translation mechanism operable to translate a second of the offset rows traverse to the longitudinal direction. The system can include an exhaust mechanism operable to collect material removed from the workpiece via the first and second outputs. The system can be configured to generate multiple outputs, for example, at least eight first outputs, at least eight second outputs, at least twelve first outputs, and/or at least twelve second outputs. The at least one scanning device can include a scanning device operable to scan the first and second outputs. The scanning device operable to scan the first and second outputs can include dual wavelength optics. The system can include a lateral translation mechanism operable to translate the at least one scanning device traverse to the longitudinal direction. The system can be incorporated into a manufacturing system that includes a plurality of scribing systems.

In another aspect, a system for scribing a workpiece is disclosed. The system includes a frame, a translation stage coupled with the frame to support the workpiece and translate the supported workpiece relative to the frame in a longitudinal direction, at least one laser coupled with the frame and operable to generate output able to remove material from at least a portion of the workpiece, and a plurality of scanning devices coupled with the frame and arranged in two or more offset rows oriented traverse to the longitudinal direction. Each scanning device is operable to control a position of an output of the at least one laser.

In many embodiments, the multi-row scribing system includes at least one additional feature and/or characteristic. For example, the system can include an adjustment mechanism to adjust a longitudinal separation between two rows of the scanning devices. The system can include a first lateral translation mechanism operable to translate a first of the offset rows of scanning devices traverse to the longitudinal direction. The system can include a second lateral translation mechanism operable to translate a second of the offset rows of scanning devices traverse to the longitudinal direction, where the second offset row is different from the first offset row. The system can include an exhaust mechanism operable to collect material removed from the workpiece for each of the two or more offset rows of scanning devices.

For a fuller understanding of the nature and advantages of the present invention, reference should be made to the ensuing detailed description and the accompanying drawings. Other aspects, objects and advantages of the invention will be apparent from the drawings and the detailed description that follows.

### BRIEF DESCRIPTION OF THE DRAWINGS

FIG. 1 is a schematic illustration of a scribed assembly used in a thin-film solar cell.

FIG. 2 illustrates a perspective view of a laser-scribing system, in accordance with many embodiments.

FIG. 3 illustrates a side view of a laser-scribing system, in accordance with many embodiments.

FIG. 4 illustrates a set of laser assemblies, in accordance with many embodiments.

FIG. 5 illustrates components of a laser assembly, in accordance with many embodiments.

FIG. 6 diagrammatically illustrates an arrangement of processing equipment in the front end of a manufacturing line for the fabrication of thin-film solar cells, in accordance with many embodiments.

FIG. 7 diagrammatically illustrates another arrangement of processing equipment in the front end of a manufacturing line for the fabrication of thin-film solar cells, in accordance with many embodiments.

FIG. 8 diagrammatically illustrates a two row arrangement of laser assemblies in a laser-scribing system, in accordance with many embodiments.

FIGS. 9A, 9B, and 9C diagrammatically illustrate arrangements of laser assemblies that can be used in a laser-scribing system, in accordance with many embodiments.

FIG. 10 discloses example laser-scribing system features in accordance with many embodiments.

FIGS. 11A, and 11B diagrammatically illustrate the use of different laser wavelengths to remove material from different workpiece layers, in accordance with many embodiments.

FIGS. 12A, 12B, and 12C summarize predicted manufacturing throughput rates for the fabrication of thin-film solar panels for a various manufacturing cells that include one or more multi-wavelength laser-scribing systems, in accordance with many embodiments.

### DETAILED DESCRIPTION

In accordance with various aspects and embodiments of the present disclosure, systems for scribing or otherwise patterning a workpiece are provided that are operable to remove material from the workpiece using laser output of a first wavelength and/or laser output of a second wavelength. Such scribing systems can be used to scribe multiple line types into the workpiece (e.g., P1 interconnect lines, P1 isolation lines, P2 interconnect lines, P3 interconnect lines, P3 isolation lines). Such an ability increases the flexibility of such a scribing system, and the increased flexibility can be used to increase manufacturing throughput during the fabrication of thin-film solar cells.

Laser-Scribing Systems

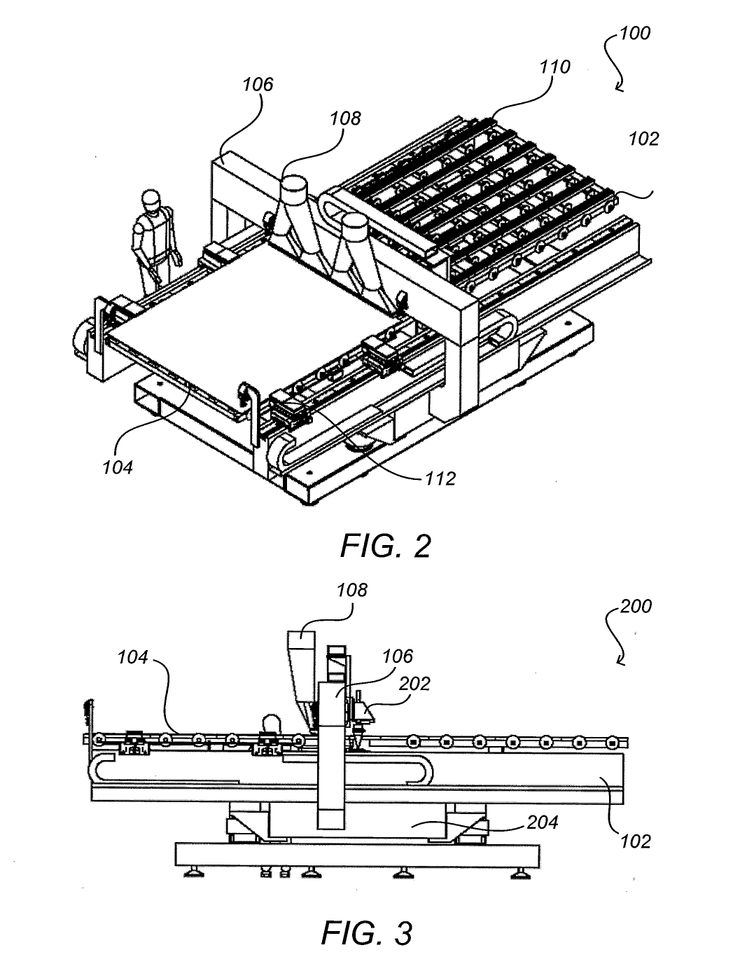

FIG. 2 illustrates an example of a laser-scribing system 100 that can be used in accordance with many embodiments. The scribing system includes a bed or stage 102, which may be level, for receiving and maneuvering a workpiece 104, such as a substrate having at least one layer deposited thereon. In one example, a workpiece is able to move along a single directional vector (i.e., for a Y-stage) at a rate of up to about 2 m/s or more. In some embodiments, the workpiece will be aligned to a fixed orientation with the long axis of the workpiece substantially parallel to the motion of the workpiece in the scribing system. The alignment can be aided by the use of the cameras or imaging devices that acquire marks on the workpiece. In this example, the lasers (shown in subsequent figures) are positioned beneath the workpiece and opposite an exhaust arm 106 holding part of an exhaust mechanism 108 for extracting material ablated or otherwise removed from the substrate during the scribing process. The workpiece 104 can be loaded onto a first end of the stage 102 with the substrate side down (towards the lasers) and the layered side up (towards the exhaust). The workpiece is received onto an array of rollers 110 and/or bearings, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assemblies. The scribing system can include at least one controllable drive mechanism 112 for controlling a direction and translation velocity of the workpiece 104 on the stage 102.

This movement is also illustrated in the side view 200 of FIG. 3, where the substrate moves back and forth along a vector that lies in the plane of the figure. Reference numbers are carried over between figures for somewhat similar elements for purposes of simplicity and explanation, but it should be understood that this should not be interpreted as a limitation on the various embodiments. As the substrate is translated back and forth on the stage 102, a scribing area of the laser assembly effectively scribes from near an edge region of the substrate to near an opposite edge region of the substrate. In order to ensure that the scribe lines are being formed properly, an imaging device can image at least one of the lines after scribing. Further, a beam profiling device 202 can be used to calibrate the beams between processing of substrates or at other appropriate times. In many embodiments where scanners are used, for example, which drift over time, a beam profiler allows for the calibrating of the beam and/or adjustment of beam position. The stage 102, exhaust arm 106, and a base portion 204 can be made out of at least one appropriate material, such as a base portion of granite.

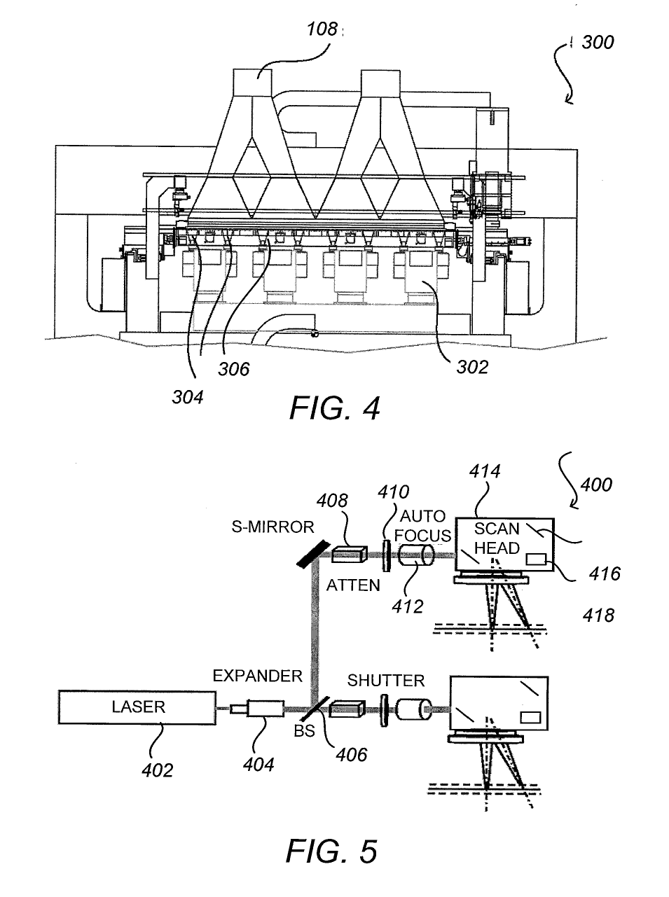

FIG. 4 illustrates an end view 300 of the example scribing system, illustrating a series of laser assemblies 302 used to scribe the layers of the workpiece. In this example, there are four laser assemblies 302, each including a laser device and elements, such as lenses and other optical elements, needed to focus or otherwise adjust aspects of the laser. The laser device can be any appropriate laser device operable to ablate or otherwise scribe at least one layer of the workpiece, such as a pulsed solid-state laser. As can be seen, a portion of the exhaust 108 is positioned opposite each laser assembly relative to the workpiece, in order to effectively exhaust material that is ablated or otherwise removed from the workpiece via the respective laser device. In many embodiments, the system is a split-axis system, where the stage translates the sample along a longitudinal axis. The lasers then can be attached to a translation mechanism able to laterally translate the lasers 302 relative to the workpiece 104. For example, the lasers can be mounted on a support that is able to translate on a lateral rail as driven by a controller and servo motor. In many embodiments, the lasers and laser optics all move together laterally on the support. As discussed below, this allows shifting scan areas laterally and provides other advantages.

In this example, each laser device actually produces two effective beams 304 useful for scribing the workpiece. As can be seen, each portion of the exhaust 108 covers a scan field, or an active area, of the pair of beams in this example, although the exhaust could be further broken down to have a separate portion for the scan field of each individual beam. The figure also shows substrate thickness sensors 306 useful in adjusting heights in the system to maintain proper separation from the substrate due to variations between substrates and/or in a single substrate. Each laser can be adjustable in height (e.g., along the z-axis) using a z-stage, motor, and controller, for example. In many embodiments, the system is able to handle 3-5 mm differences in substrate thickness, although many other such adjustments are possible. The z-motors also can be used to adjust the focus of each laser on the substrate by adjusting the vertical position of the laser itself.

In order to provide the pair of beams, each laser assembly includes at least one beam splitting device. FIG. 5 illustrates basic elements of an example laser assembly 400 that can be used in accordance with many embodiments, although it should be understood that additional or other elements can be used as appropriate. In this assembly 400, a single laser device 402 generates a beam that is expanded using a beam expander 404 then passed to a beam splitter 406, such as a partially transmissive mirror, half-silvered mirror, prism assembly, etc., to form first and second beam portions. In this assembly, each beam portion passes through an attenuating element 408 to attenuate the beam portion, adjusting an intensity or strength of the pulses in that portion, and a shutter 410 to control the shape of each pulse of the beam portion. Each beam portion then also passes through an auto-focusing element 412 to focus the beam portion onto a scan head 414. Each scan head 414 includes at least one element capable of adjusting a position of the beam, such as a galvanometer scanner useful as a directional deflection mechanism. In many embodiments, this is a rotatable mirror able to adjust the position of the beam along a lateral direction, orthogonal to the movement vector of the workpiece, which can allow for adjustment in the position of the beam relative to the intended scribe position. The scan heads then direct each beam concurrently to a respective location on the workpiece. A scan head also can provide for a short distance between the apparatus controlling the position for the laser and the workpiece. Therefore, accuracy and precision is improved. Accordingly, the scribe lines may be formed more precisely (i.e., a scribe 1 line can be closer to a scribe 2 line) such that the efficiency, of a completed solar module is improved over that of existing techniques.

In many embodiments, each scan head 414 includes a pair of rotatable mirrors 416, or at least one element capable of adjusting a position of the laser beam in two dimensions (2D). Each scan head includes at least one drive element 418 operable to receive a control signal to adjust a position of the “spot” of the beam within the scan field and relative to the workpiece. In one example, a spot size on the workpiece is on the order of tens of microns within a scan field of approximately 60 mm×60 mm, although various other dimensions are possible. While such an approach allows for improved correction of beam position on the workpiece, it can also allow for the creation of patterns or other non-linear scribe features on the workpiece. Further, the ability to scan the beam in two dimensions means that any pattern can be formed on the workpiece via scribing without having to rotate the workpiece.

Manufacturing Cells for Multi-Wavelength Laser-Scribing Systems

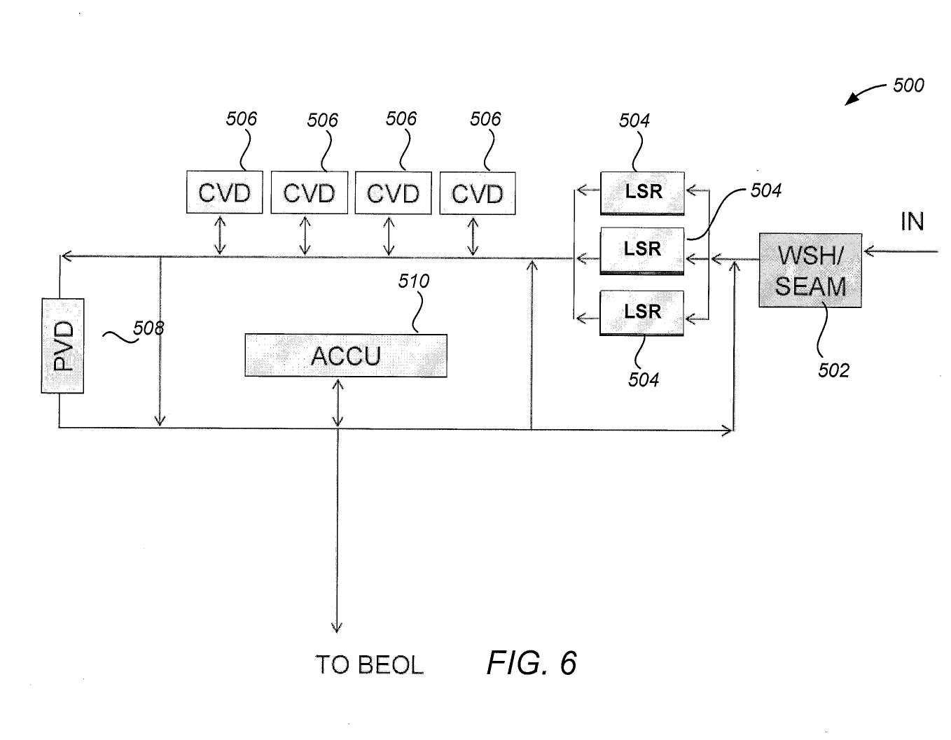

FIG. 6 diagrammatically illustrates a manufacturing cell 500 that utilizes one or more multi-wavelength laser-scribing systems for the fabrication of thin-film solar cells, in accordance with many embodiments. The manufacturing cell 500 includes a washing/seaming station 502, three laser-scribing systems 504, four chemical vapor deposition stations 506, a physical vapor deposition station 508, and a buffer station 510. One or more of the three laser-scribing systems 504 can be a herein disclosed multi-wavelength laser-scribing system capable of scribing multiple scribe line types (e.g., P1 interconnect lines, P1 isolation lines, P2 interconnect lines, P3 interconnect lines, P3 isolation lines).

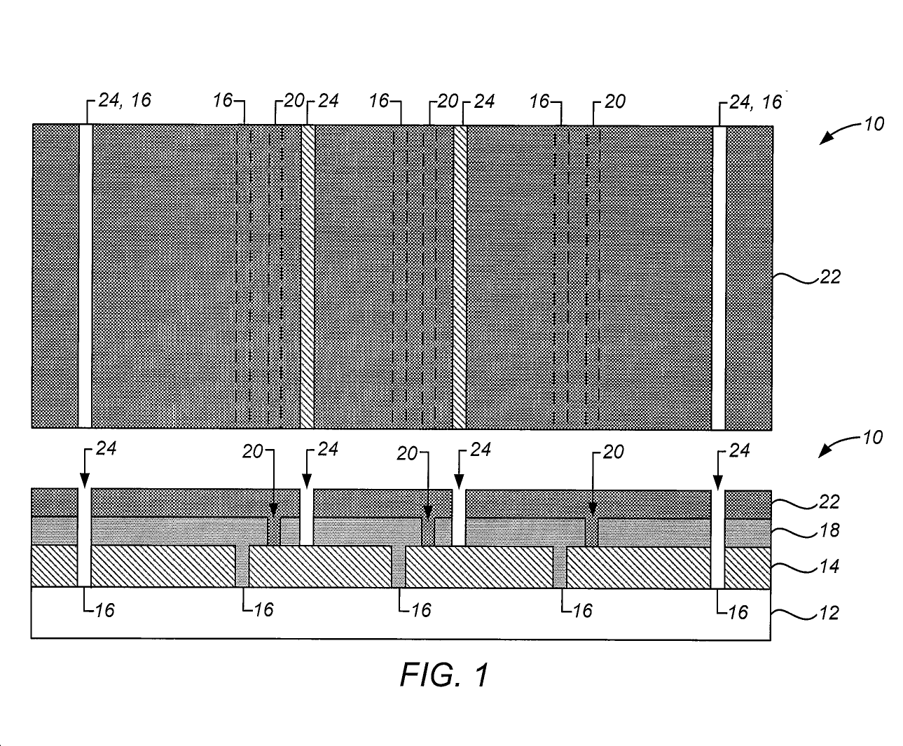

The manufacturing cell 500 is operable to fabricate a solar-cell assembly, such as the solar-cell assembly 10 of FIG. 1, used in a thin-film solar cell. In operation, the workpiece 10 comprising the glass substrate 12 and the TCO layer 14 is first processed in the washing/seaming station 502, where the workpiece 10 is washed and the edges of the workpiece are ground to produce an edge detail that is less likely to crack. The workpiece is then transferred to one of the three laser-scribing systems 504, where the first set of lines 16 (e.g., P1 interconnect lines, and in some instances, P1 isolation lines) are scribed into the TCO layer 14. The workpiece is then transferred to the chemical vapor deposition stations 506, where the plurality of doped and undoped amorphous silicon (a-Si) layers 18 are then deposited on the TCO layer 14 and within the first set of lines 16. The workpiece is then transferred back to one of the three laser-scribing systems 504, where the second set of lines 20 (“P2” interconnect lines) are then scribed within the silicon layers 18. The workpiece is then transferred to the physical vapor deposition station 508, where the metal layer 22 is then deposited on the silicon layers 18 and within the second set of lines 20. The workpiece is then transferred back to one of the three laser-scribing systems 504, where the third set of lines 24 (“P3” interconnect lines and “P3” isolation lines) are then scribed. The workpiece is then transferred to the buffer station 510, where it may be held prior to being transferred to the back end of the manufacturing line (BEOL).

The use of one or more multi-wavelength laser-scribing systems in the manufacturing cell 500 provides increased flexibility relative to arrangements of processing equipment that use dedicated laser-scribing systems for the scribing of each type of laser-scribed lines (e.g., the first set of lines 16, the second set of lines 20, the third set of lines 24). For example, the three laser-scribing systems 504 can include a first system that generates infrared laser output, a second system that is operable to selectively generate infrared laser output or green laser output, and a third system that generates green laser output. Either of such first and second systems can be used to produce scribe lines requiring the removal of a portion of the TCO layer 14, and either of the second and third systems can be used to produce scribe lines not requiring the removal of a portion of the TCO layer 14. Throughput through the manufacturing cell 500 can be increased by increased usage balance made possible by the second system's increased flexibility. Additionally, such a configuration allows one of the laser-scribing systems 504 to be offline (e.g., for maintenance, for repair) and the manufacturing cell 500 can still be operated to produce solar-cell assemblies 10 on the remaining online laser-scribing systems 504. Additional numbers and/or combinations of laser-scribing systems 504 can be used, for example, two or three of the laser-scribing systems 504 can be multi-wavelength laser-scribing systems.

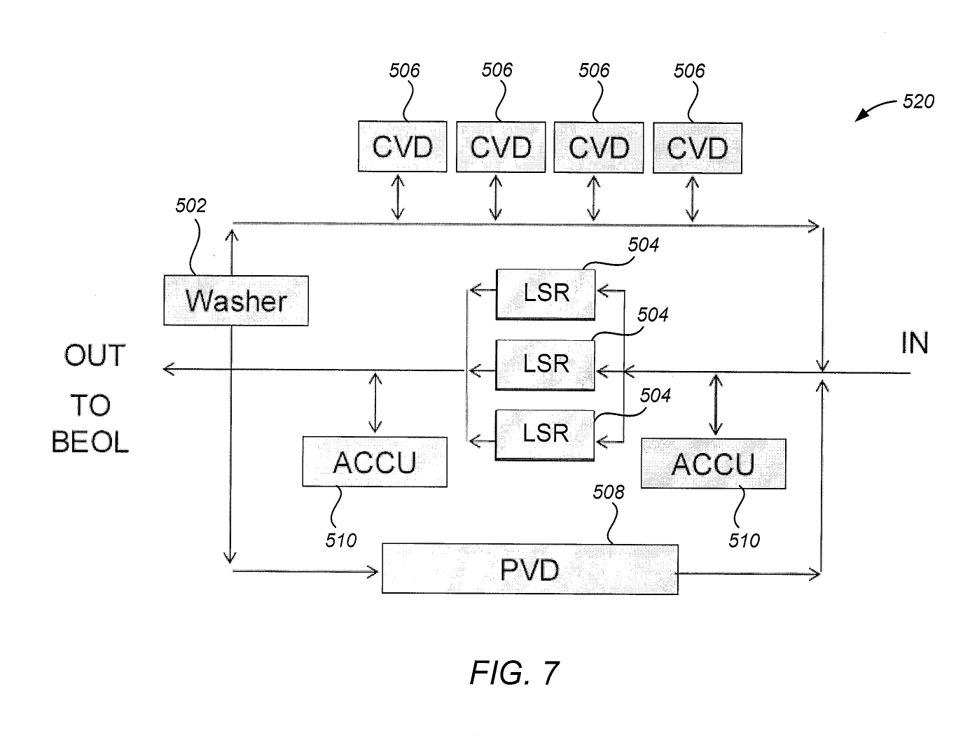

FIG. 7 diagrammatically illustrates another manufacturing cell 520 that utilizes one or more multi-wavelength laser-scribing systems for the fabrication of thin-film solar cells, in accordance with many embodiments. The manufacturing cell 520 is similar to the manufacturing cell 500 of FIG. 6, but is arranged differently and includes two buffer stations 510.

In many embodiments, a laser-scribing system is configured to scribe P3 lines with a 532 nm output and to scribe isolation and hot spot lines with a 1064 nm output. Such a laser-scribing system can be used to eliminate the scribing of P1 isolation lines as describe in U.S. patent application Ser. No. 12/851,422, entitled “METHODS AND RELATED SYSTEMS FOR THIN-FILM LASER SCRIBING ENHANCED THROUGHPUT,” filed on Aug. 5, 2010, which was incorporated by reference above. Eliminating the scribing of P1 isolation lines enables improved manufacturing throughput during the scribing of workpieces to form P1 lines.

In many embodiments, the laser-scribing system used to scribe P3 lines is configured to generate 532 nm wavelength output with a width appropriate for interconnect line scribing, and is further configured to generate 532 nm wavelength output with a wider width (e.g., 1 mm wide) for scribing wider P3 interconnect lines suitable for building integrated photovoltaic (BIPV) applications. For example, the wider P3 interconnect lines generated by the wider 532 nm wavelength output can be used to fabricate (Semi)transparent modules that can be used to replace a number of architectural elements commonly made with glass or similar materials, such as windows and skylights.

Multi-Wavelength Laser-Scribing Systems

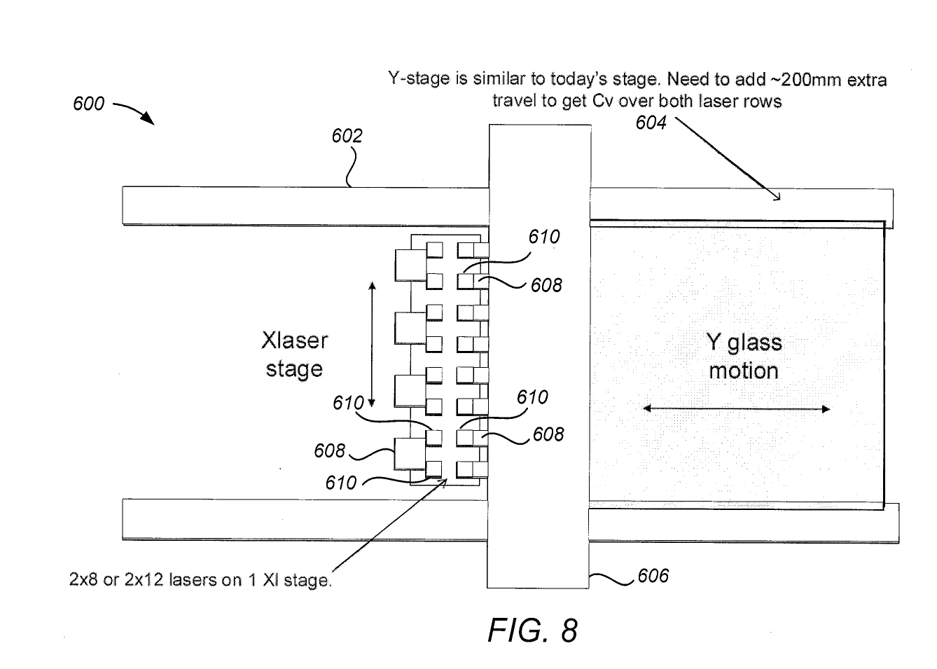

FIG. 8 diagrammatically illustrates a multi-wavelength laser-scribing system 600, in accordance with many embodiments. The laser-scribing system 600 can include any of the features of the above-described laser-scribing system 100. For example, the laser-scribing system 600 includes a frame 602, a translation stage 604, a bridge 606, a plurality of lasers 608, and a plurality of scanning devices 610 arranged in two offset rows. The lasers 608 and the scanning devices 610 can be integrated into one or more separate laser assemblies (e.g., the above-described laser assembly 400 shown in FIG. 5). The lasers 608 and the scanning devices 610 can be mounted for movement by one or more lateral translation mechanism (e.g., an X-laser stage 612) operable to translate the lasers and the scanning devices traverse to the movement direction of the workpiece generated by the translation stage 604. The longitudinal separation between the offset rows can be selected to correspond to a nominal separation between traverse scribed lines in the solar-cell assemblies produced, for example, the separation can be approximately 200 mm. In many embodiments, the longitudinal separation between rows can be adjusted via an adjustment mechanism. Different numbers of lasers, scanning devices, or laser-assemblies can be used. For example, a row can comprise four laser assemblies, with each laser assembly including two scanning devices so as to generate a total of eight outputs from the row. A row can also include eight laser assemblies, with each laser assembly including one scanning device so as to generate a total of eight outputs from the row. More or fewer outputs can be used per row, for example, twelve outputs per row can be used.

The laser assemblies of the laser-scribing system 600 can include one or more lasers to generate the laser output having a first wavelength and the laser output having a second wavelength. For example, a single laser(s) can be used to generate both output wavelengths by selectively using second-harmonic generation to double the frequency of the basic output of the laser (e.g., selectively using second-harmonic generation to convert a 1064 nm laser output to a 532 nm output). As another example, a first set of one or more lasers can be used to generate the laser output(s) having a first wavelength (e.g., infrared output at 1064 nm), and a separate second set of one or more lasers can be used to generate the laser output(s) having a second wavelength (e.g., green laser output at 532 nm). The first set of lasers can be disposed on one row and the second set of lasers can be disposed on the other row. Alternatively, the first and second sets can be disposed on both rows.

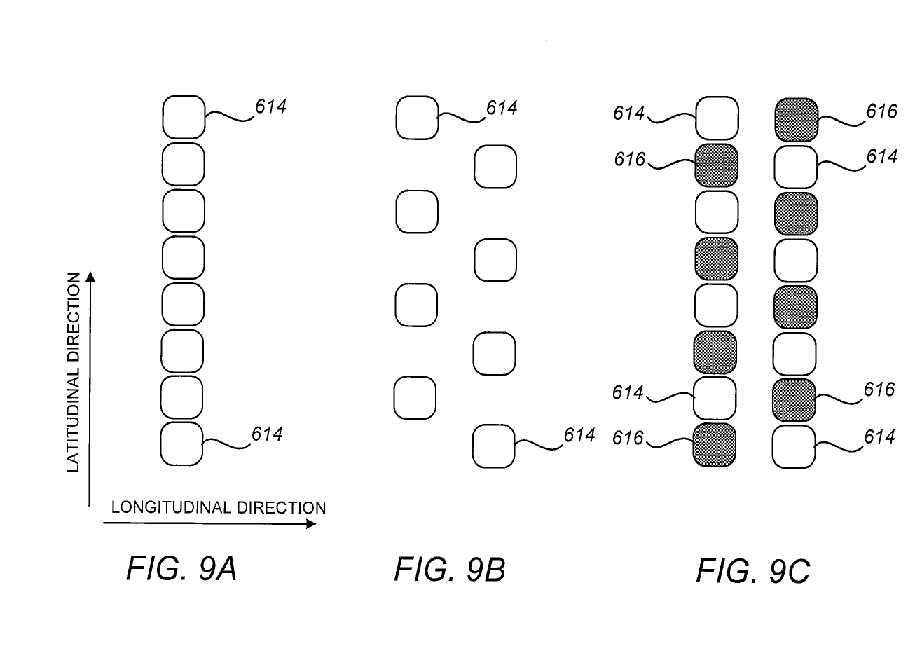

In addition, lasers and/or scanning devices can be arranged in multiple rows so that multiple latitudinal lines can be scribed simultaneously. In thin-film solar applications, lasers are typically arranged in a row, which is beneficial to increase the throughput of scribing in the stage motion direction of the translation stage. However, such an arrangement is not optimal with regard to throughput of scribing lines traverse to the stage motion direction of the translation stage. For example, FIG. 9A illustrates a single row arrangement of scanning devices 614. While the arrangement of FIG. 9A provides for the scribing of eight lines at a time in the longitudinal direction, only one line can be scribed at a time in the latitudinal direction (at least for typical longitudinal separations used between latitudinal scribe lines). In contrast, the two row arrangement of the scanning devices 614 in FIG. 9B also provides for the ability to scribe eight lines at a time in the longitudinal direction, and the ability to scribe two lines at a time in the latitudinal direction thereby providing increased flexibility in dual-direction scribing. FIG. 9C illustrates a two row arrangement of scanning devices 614, 616 that can be used in a system operable to generate laser-scribing output of two different wavelengths. For example, the scanning devices 614 can be used to scan output from a first set of lasers having a first wavelength (e.g., an infrared wavelength such as 1064 nm), and the scanning devices 616 can be used to scan output from a second set of lasers having a second wavelength (e.g., a green wavelength such as 532 nm). Thus, regardless of the wavelength used, the arrangement of FIG. 9C can be used to simultaneously scribe eight lines in the longitudinal direction, and can be used to simultaneously scribe two lines in the latitudinal direction.

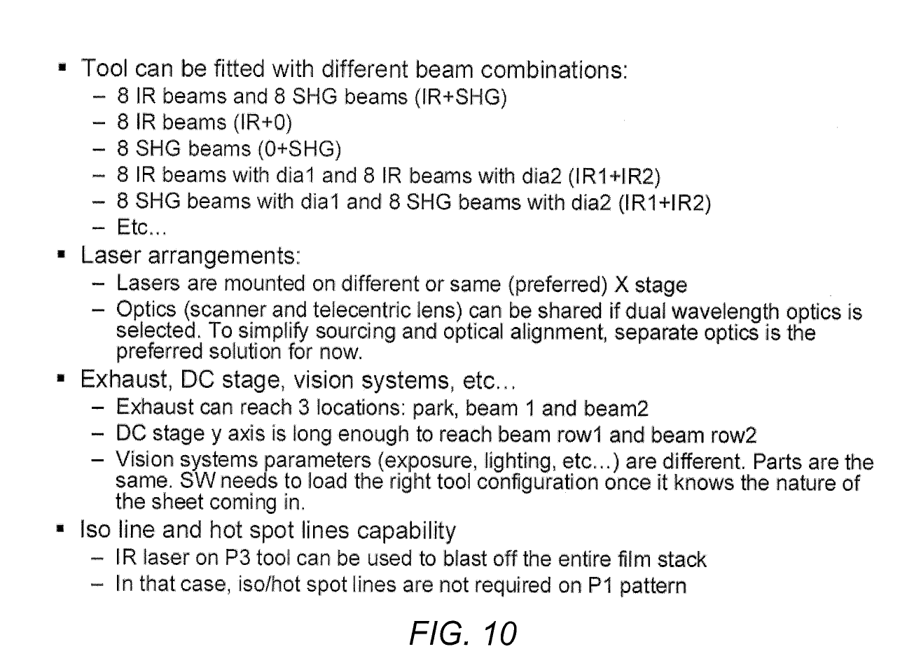

FIG. 10 discloses example laser-scribing system features in accordance with many embodiments. As discussed above, a laser-scribing system can be configured to generate laser output of multiple wavelengths. For example, a laser-scribing system can be configured with eight infrared beams (e.g., 1064 nm) and eight second-harmonic generation beams (e.g., green wavelength at 532 nm). A laser-scribing system can be configured with eight infrared beams and zero second-harmonic generation beams. A laser-scribing system can be configured with zero infrared beams and eight second-harmonic generation beams. A laser-scribing system can be configured with eight infrared beams having a first diameter and eight infrared beams having a second diameter. A laser-scribing system can be configured with eight second-harmonic generation beams having a first diameter and eight second-harmonic generation beams having a second diameter, etc. Any suitable number/types of beams can be used, and eight beams are used above for illustration purposes only.

Various laser and/or scanning device arrangements can be used. For example, laser assemblies (e.g., the above describe laser assembly 400 shown in FIG. 5) can be mounted on different lateral translation mechanisms or on a single lateral translation mechanism (X-stage). The optics of one or more of the scanning devices (e.g., scanner, telecentric lens) can be shared, for example, and dual wavelength optics can be used. However, to simplify sourcing and optical alignment, separate optics can be used, and is presently preferred.

Other laser-scribing system components can be configured for the use of multi-wavelength laser output and/or for the use of multi-row arrangements of laser assemblies. For example, an exhaust system can be configured to be positioned to three separate locations, specifically a park position not covering workpiece ablation areas, a first beam position covering areas on the workpiece ablated by a first set of laser assemblies arranged in a first row, and a second beam position covering areas on the workpiece ablated by a second set of the laser assemblies arranged in a second row. A lateral translation mechanism (DC stage) can be configured to reach the first beam row and the second beam row.

The use of multi-wavelength laser output impacts vision system parameters (exposure, lighting, etc.). Although vision system components for a multi-wavelength system can be the same as for a single-wavelength system, the software controlling the vision system can be configured to account for the different vision system parameters based on the nature of the workpiece to be processed (e.g., to scribe P1 lines, to scribe P2 lines, to scribe P3 lines).

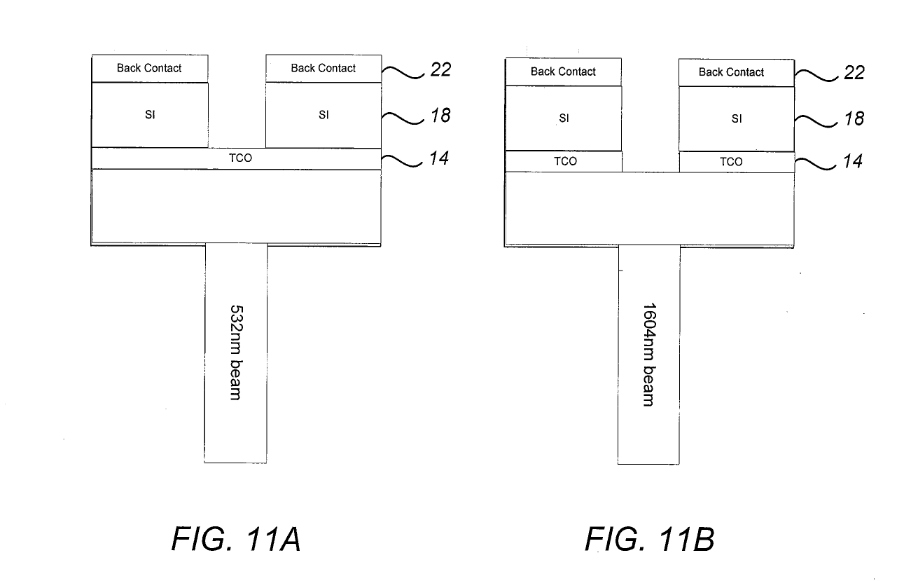

FIGS. 11A, and 11B diagrammatically illustrate the use of different laser wavelengths to remove material from different workpiece layers, in accordance with many embodiments. FIG. 11A illustrates the use of a 532 nm wavelength laser output to remove material from the silicon layer 18 and the metal back layer 22. FIG. 11B illustrates the use of a 1064 nm wavelength laser output to remove material from all layers, specifically from the TCO layer 14, the silicon layer 18, and the metal back layer 22. The ability to remove material from all layers enables the revised scribing sequence described in U.S. patent application Ser. No. 12/851,422, entitled “METHODS AND RELATED SYSTEMS FOR THIN-FILM LASER SCRIBING ENHANCED THROUGHPUT,” filed on Aug. 5, 2010, the full disclosure of which was incorporated by reference above.

Throughput Predictions

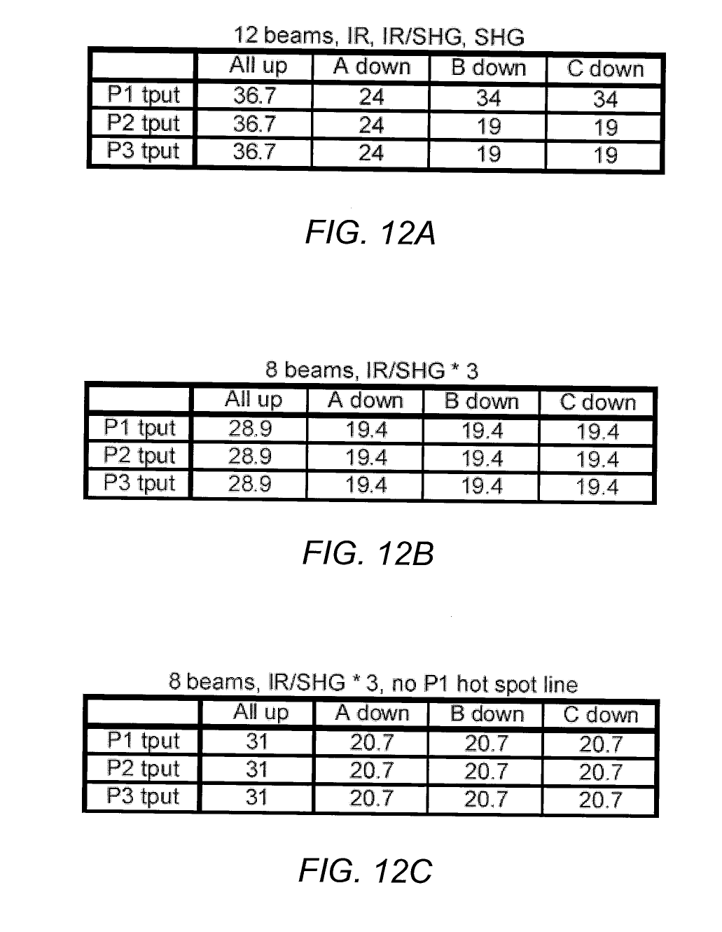

FIGS. 12A, 12B, and 12C summarize predicted manufacturing throughput rates for the fabrication of thin-film solar panels for a various manufacturing cells that include one or more multi-wavelength laser-scribing systems, in accordance with many embodiments. FIG. 12A presents predicted throughput for a manufacturing cell that includes three laser-scribing systems, where each system generates twelve scribing beams. The first of the three systems (system “A”) is configured to generate infrared output, the second of the three systems (system “B) is configured to selectively generate either infrared output or second-generation harmonic output, and the third of the three systems (system “C) is configured to generate second-generation harmonic output. When all three systems are online in one embodiment, the predicted throughput for the scribing of P1 scribe lines is 36.7 workpieces per hour, the predicted throughput for the scribing of P2 scribe lines is 36.7 workpieces per hour, and the predicted throughput for the scribing of P3 scribe lines is 36.7 workpieces per hour. When system “A” offline, the predicted throughput for the scribing of P1 scribe lines is 24 workpieces per hour, the predicted throughput for the scribing of P2 scribe lines is 24 workpieces per hour, and the predicted throughput for the scribing of P3 scribe lines is 24 workpieces per hour. When system “B” offline, the predicted throughput for the scribing of P1 scribe lines is 34 workpieces per hour, the predicted throughput for the scribing of P2 scribe lines is 19 workpieces per hour, and the predicted throughput for the scribing of P3 scribe lines is 19 workpieces per hour. When system “C” offline, the predicted throughput for the scribing of P1 scribe lines is 34 workpieces per hour, the predicted throughput for the scribing of P2 scribe lines is 19 workpieces per hour, and the predicted throughput for the scribing of P3 scribe lines is 19 workpieces per hour. FIG. 12B presents predicted throughput for a manufacturing cell that includes three laser-scribing systems, where each system generates eight scribing beams, and each system is configured to selectively generate either infrared output or second-generation harmonic output. FIG. 12C presents predicted throughput for a manufacturing cell configured the same as for FIG. 12B, but in which the revised scribing sequence described in U.S. patent application Ser. No. 12/851,422, entitled “METHODS AND RELATED SYSTEMS FOR THIN-FILM LASER SCRIBING ENHANCED THROUGHPUT,” filed on Aug. 5, 2010, is employed.

Such throughput predictions can be used in combination with cost information to select the particular combinations of laser-scribing systems for use in a manufacturing cell. For example, the configuration of FIG. 12A may provide the best overall value, whereas the configuration of FIGS. 12B and 12C is the most flexible. Additionally, an eight-beam version of the configuration of FIG. 12A may provide the lowest system procurement cost.

It is understood that the examples and embodiments described herein are for illustrative purposes and that various modifications or changes in light thereof will be suggested to a person skilled in the art and are to be included within the spirit and purview of this application and the scope of the appended claims. Numerous different combinations are possible, and such combinations are considered to be part of the present invention.

What is claimed is:

1. A system for scribing a workpiece, the system comprising:
a frame;
a translation stage coupled with the frame to support the workpiece and translate the supported workpiece relative to the frame in a longitudinal direction;
at least one laser coupled with the frame and operable to
generate a first output having a first wavelength to remove material from at least a first portion of the workpiece, and
generate a second output having a second wavelength to remove material from at least a second portion of the workpiece; and
at least one scanning device coupled with the frame and operable to control a position of the first and second outputs.

2. The system of claim 1, wherein the first wavelength is an infrared wavelength.

3. The system of claim 1, wherein the second wavelength is a green wavelength.

4. The system of claim 1, wherein the at least one laser comprises:
at least one first laser operable to generate the first output; and
at least one second laser operable to generate the second output.

5. The system of claim 1, wherein the at least one scanning device comprises a plurality of scanning devices arranged in two or more offset rows oriented traverse to the longitudinal direction.

6. The system of claim 5, further comprising an adjustment mechanism to adjust a longitudinal separation between two rows of scanning devices.

7. The system of claim 5, further comprising a first lateral translation mechanism operable to translate a first of the offset rows traverse to the longitudinal direction.

8. The system of claim 7, further comprising a second lateral translation mechanism operable to translate a second of the offset rows traverse to the longitudinal direction.

9. The system of claim 5, further comprising an exhaust mechanism operable to collect material removed from the workpiece via the first and second outputs.

10. The system of claim 1, wherein the system is operable to generate at least eight first outputs and at least eight second outputs.

11. The system of claim 10, wherein the system is operable to generate at least twelve first outputs and at least twelve second outputs.

12. The system of claim 1, wherein the at least one scanning device comprises a scanning device operable to scan the first and second outputs.

13. The system of claim of claim 12, wherein the scanning device operable to scan the first and second outputs comprises dual wavelength optics.

14. The system of claim 1, further comprising a lateral translation mechanism operable to translate the at least one scanning device traverse to the longitudinal direction.

15. A manufacturing system comprising a plurality of scribing systems for scribing a workpiece, the plurality of scribing systems having at least a system comprising:
a frame;
a translation stage coupled with the frame to support the workpiece and translate the supported workpiece relative to the frame in a longitudinal direction;
at least one laser coupled with the frame and operable to
generate a first output having a first wavelength to remove material from at least a first portion of the workpiece, and
generate a second output having a second wavelength to remove material from at least a second portion of the workpiece; and
at least one scanning device coupled with the frame and operable to control a position of the first and second outputs.

16. A system for scribing a workpiece, the system comprising:
a frame;
a translation stage coupled with the frame to support the workpiece and translate the supported workpiece relative to the frame in a longitudinal direction;
at least one laser coupled with the frame and operable to generate output able to remove material from at least a portion of the workpiece; and
a plurality of scanning devices coupled with the frame and arranged in two or more offset rows oriented traverse to the longitudinal direction, each scanning device operable to control a position of an output of the at least one laser.

17. The system of claim 16, further comprising an adjustment mechanism to adjust a longitudinal separation between two rows of the scanning devices.

18. The system of claim 16, further comprising a first lateral translation mechanism operable to translate a first of the offset rows of scanning devices traverse to the longitudinal direction.

19. The system of claim 18, further comprising a second lateral translation mechanism operable to translate a second of the offset rows of scanning devices traverse to the longitudinal direction, the second offset row being different from the first offset row.

20. The system of claim 16, further comprising an exhaust mechanism operable to collect material removed from the workpiece for each of the two or more offset rows of scanning devices.
